(19) United States
(12) Patent Application Publication
(10) Pub. No.: US 2011/0182050 A1
(43) Pub. Date: Jul. 28, 2011

(54) Polarized Linear Light Source

(75) Inventors: Udayan Kanade, Pune (IN); Pushkar Apte, Rochester, NY (US); Ruby Rama Praveen, Pune (IN); Sanat Ganu, Pune (IN); Sumeet Katariya, Pune (IN); Alok Deshpande, Madison, WI (US); Parag Khairnar, Bengaluru (IN)

(73) Assignee: I2IC CORPORATION, Foster City, CA (US)

(21) Appl. No.: 12/933,428

(22) PCT Filed: Mar. 19, 2009
(86) PCT No.: PCT/IB2009/051172

§ 371 Date: Feb. 1, 2011

(30) Foreign Application Priority Data
Mar. 19, 2008 (IN) 550/MUM/2008

(51) Int. Cl. F21V 13/08

(52) U.S. Cl. 362/19

(57) ABSTRACT

An energy efficient polarized linear light source system is disclosed. In one embodiment, the system comprises a reflector and a reflecting polarizer. A transparent linear light source and a quarter wave retarder are placed in between the reflector and reflecting polarizer. The polarized linear light source may be used as an illuminator for an efficient polarized surface light source.

This application claims priority from provisional patent application number 550/MUM/2008 titled “A Polarized Linear Light Source” dated 19 Mar. 2008 filed in Mumbai, India.

### TECHNICAL FIELD

The present invention relates to an illuminator for a light source. More particularly, the invention relates to an energy efficient polarized linear illuminator for a light source.

### BACKGROUND ART

Light from most light sources is randomly polarized. However, several applications require linearly or circularly polarized light. For example, many light valves (such as liquid crystal light valves used in displays) and optical processors require polarized light.

Prior art systems exist for light sources which convert randomly polarized light to polarized light. Some prior art systems use a polarizer in front of the light source. Unpolarized light passes through the polarizer and polarized light emerges out from it. Such systems are inefficient since polarizers allow transmission of one polarization component but absorb the other polarization component. Thus approximately half the light energy is dissipated in the polarizer. Other prior art systems use polarizing beam splitters for polarizing light. Polarizing beam splitters allow the required polarization component to pass through, however, the unwanted polarization component is deflected away and its energy is dissipated elsewhere. Therefore, such systems are also inefficient.

A reflecting polarizer is a device which permits one polarization component to pass through, but reflects back the other polarization component. In some prior art systems, this other polarization component is recycled using diffusers and reflectors, and some of it returns to the reflecting polarizer. Some of this returning light is polarized correctly, and hence passed by the reflecting polarizer. Though this increases polarization efficiency, this system of reflecting and randomizing polarization is lossy and inefficient.

### DISCLOSURE OF INVENTION

### Summary

An energy efficient polarized linear light source system is disclosed. In one embodiment, the system comprises a reflector and a reflecting polarizer. A transparent linear light source and a quarter wave retarder are placed in between the reflector and reflecting polarizer. The polarized linear light source may be used as an illuminator for an efficient polarized surface light source.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary arrangement of a polarized linear light source, according to an embodiment.

FIG. 2A illustrates a block diagram of a cross section of an exemplary polarized linear light source, according to an embodiment.

FIG. 2B illustrates polarization states of exemplary light rays in a polarized linear light source, according to an embodiment.

FIG. 3A illustrates a block diagram of a cross section of an exemplary polarized linear light source, according to an embodiment.

FIG. 3B illustrates polarization states of exemplary light rays in a polarized linear light source, according to an embodiment.

FIG. 4A illustrates a block diagram of a cross section of an exemplary polarized linear light source, according to an embodiment.

FIG. 4B illustrates polarization states of exemplary light rays in a polarized linear light source, according to an embodiment.

FIG. 5A illustrates a block diagram of a cross section of an exemplary polarized linear light source, according to an embodiment.

FIG. 5B illustrates polarization states of exemplary light rays in a polarized linear light source, according to an embodiment.

FIG. 6 illustrates a linear light source, according to one embodiment.

FIG. 7 illustrates an exemplary element of a light guide having light deflector, according to one embodiment.

FIG. 8 illustrates an exemplary linear light source having a varied concentration of light deflecting particles, according to one embodiment.

FIG. 9 illustrates an exemplary linear light source having two light sources, according to one embodiment.

FIG. 10 illustrates an exemplary linear light source having a mirrored light guide, according to one embodiment.

FIG. 11 illustrates a block diagram of an exemplary light source, according to one embodiment.

FIG. 12 illustrates an exemplary light source, as seen from the side, according to one embodiment.

FIG. 13 illustrates a block diagram of an exemplary light source as viewed from the side, according to one embodiment.

### DETAILED DESCRIPTION

An energy efficient polarized linear light source system is disclosed. In one embodiment, the system comprises a reflector and a reflecting polarizer. A transparent linear light source and a quarter wave retarder are placed in between the reflector and reflecting polarizer. The polarized linear light source may be used as an illuminator for an efficient polarized surface light source.

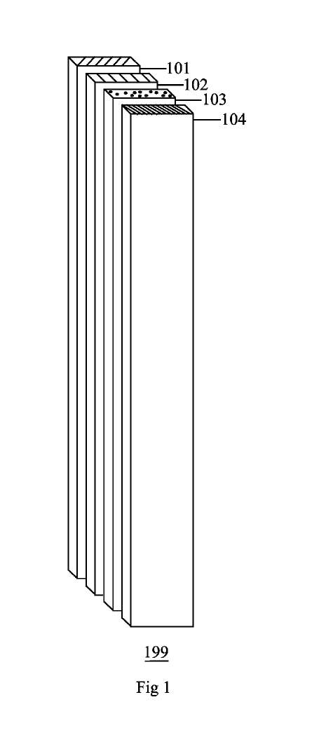

FIG. 1 illustrates a block diagram of an exemplary arrangement of a polarized linear light source 199, according to one embodiment. The apparatus comprises a mirror 101. A mirror is any light reflector, including metallic surfaces, distributed Bragg reflectors, hybrid reflectors, total internal reflectors, omni-direction reflectors or scattering reflectors. A quarter wave retarder 102 is placed in front of mirror 101. A transparent linear light source 103 is placed in front of the quarter wave retarder 102. A reflecting polarizer 104 is placed in front of the transparent linear light source 103. Transparent linear light source 103 is a light source extended in one dimension that is transparent to light falling on it from outside. The reflecting polarizer 104 allows one polarization to pass through it, but reflects back the other polarization. The apparatus 199 is an energy efficient linear light source which emits polarized light. In an alternate embodiment, the quarter wave retarder is placed between the transparent linear light source 103 and reflecting polarizer 104.

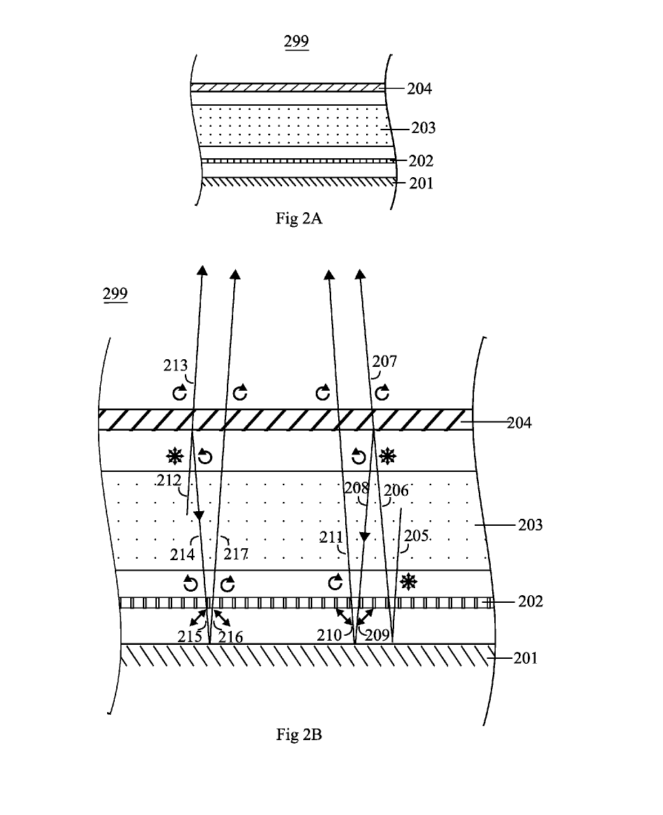

FIG. 2A illustrates a block diagram of a cross section of an exemplary polarized linear light source 299, according to one embodiment. The polarized linear light source 299 comprises a mirror 201. A quarter wave retarder 202 is placed in front of mirror 201. A transparent linear light source 203 is placed in front of the quarter wave retarder 202. A reflecting circular polarizer 204 is placed in front of the transparent linear light source 203. The reflecting circular polarizer 204 allows one circular polarization to pass through it, but reflects back the other circular polarization. The apparatus 299 is an energy efficient linear light source which emits circularly polarized light.

FIG. 2B illustrates polarization states of exemplary light rays in a polarized linear light source 299, according to an embodiment. Light is extracted from the transparent linear light source 203 from both its faces. Light 212 is extracted from the front face of the transparent linear light source 203. Extracted light 212, which is unpolarized, is incident on the reflecting polarizer 204. Circularly polarized light component 213 of light 212 of a particular handedness emerges out from the reflecting polarizer 204. Circularly polarized light component 214 of light 212 of the opposite handedness is reflected back by the reflective polarizer 204. Circularly polarized light component 214 passes through the transparent linear light source 203. The linear light source 203 being transparent, the polarization state of light 214 is retained. Further, light 214 is incident on the quarter wave retarder 202. Circularly polarized light 214 passes through the quarter wave retarder 202 and becomes linearly polarized light 215. Linearly polarized light 215 is reflected from the mirror surface 201. Mirror reflection of light 215 retains its polarization state. Reflected linearly polarized light 216 passes through the quarter wave retarder 202 and becomes circularly polarized in a handedness opposite to that of light 214. Circularly polarized light 217 passes through the transparent light source 203 and is incident on the reflecting polarizer 204. The light source 203 being transparent, the polarization state of light 217 is retained. Light 217 is circularly polarized in a handedness which is transmitted by the reflecting polarizer 204. Light 217 passes through the reflecting polarizer 204. Thus, the light 212 extracted from the front face of the transparent light source 203 gets circularly polarized and emanates out from the reflecting polarizer 204.

Light 205 depicts exemplary light which is extracted from the back face of the transparent linear light source 203. Extracted light 205, which is unpolarized, passes through the quarter wave retarder 202 and remains unpolarized. Further, light 205 reflects from the mirror 201. Reflected light 206, which is unpolarized, passes through the transparent linear light source 203. Further, light 206 is incident on the reflecting polarizer 204. Circularly polarized light component 207 of light 206 of a particular handedness emerges out from the reflecting polarizer 204. Circularly polarized light component 208 of light 206 of the opposite handedness is reflected back by the polarizer 204. Circularly polarized light component 208 passes through the transparent linear light source 203. The linear light source 203 being transparent, the polarization state of light 208 is retained. Further, circularly polarized light component 208 passes through the quarter wave retarder 202 and becomes linearly polarized. Linearly polarized light 209 is reflected from the mirror surface 201. Mirror reflection of linearly polarized light 209 retains its polarization state. Reflected linearly polarized light 210 passes through the quarter wave 202 and becomes circularly polarized in a handedness opposite to that of circularly polarized light component 208. Circularly polarized light 211 passes through the transparent linear light source 203 and is incident on the reflecting polarizer 204. The linear light source 203 being transparent, the polarization state of light 211 is retained. Light 211 is circularly polarized in a handedness which is transmitted by the reflecting polarizer 204. Light 211 passes through the reflecting polarizer 204. Thus, the light 205 extracted from the back face of the transparent light source gets circularly polarized and emanates out from the reflecting polarizer 204. Thus, light extracted from both the faces of the transparent light source emerges out from the apparatus in a circularly polarized state.

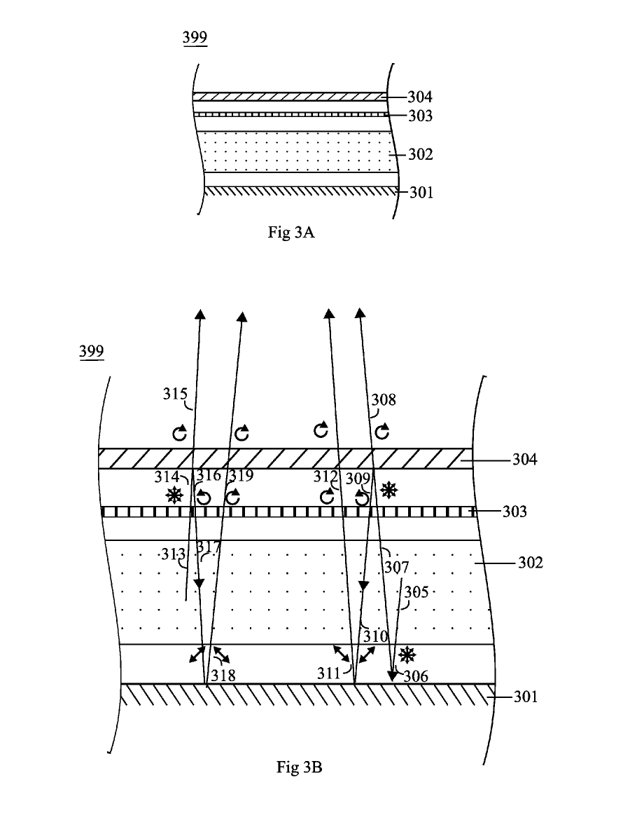

FIG. 3A illustrates a block diagram of a cross section of an exemplary polarized linear light source 399, according to one embodiment. The polarized linear light source 399 comprises a mirror 301. A transparent linear light source 302 is placed in front of the mirror 301. A quarter wave retarder 303 is placed in front of transparent linear light source 302. A reflecting circular polarizer 304 is placed in front of the quarter wave retarder 303. The reflecting circular polarizer 304 allows one circular polarization to pass through it, but reflects back the other circular polarization. The apparatus 399 is an energy efficient light source which emits circularly polarized light.

FIG. 3B illustrates polarization states of exemplary light rays in a polarized linear light source 399, according to an embodiment. Light is extracted from the transparent linear light source 302 from both its faces. Light 313 is extracted from the front face of the transparent linear light source 302. Extracted light 313, which is unpolarized, passes through the quarter wave retarder 303 and remains unpolarized. Unpolarized light 314 is incident on the reflecting polarizer 304. Circularly polarized light component 315 of light 314 of a particular handedness is transmitted through the reflecting polarizer 304. Circularly polarized light component 316 of light 314 of the opposite handedness is reflected back by the reflecting polarizer 304. Circularly polarized component 316 passes through the quarter wave retarder and becomes linearly polarized. Linearly polarized light 317 passes through the transparent linear light source 302 and reflects from the mirror 301. The linear light source 302 being transparent, the polarization state of light 317 is retained. Mirror reflection of light 317 retains its polarization. Reflected linearly polarized light 318 passes through the transparent linear light source 302. The linear light source 302 being transparent, the polarization state of light 318 is retained. Further, light 318 passes through the quarter wave retarder 302 and becomes circularly polarized in a handedness opposite to that of light 316. Circularly polarized light 319 has a handedness which is transmitted by the reflecting polarizer 304. Circularly polarized light 319 passes through the reflecting polarizer 304. Thus, light 313 extracted from the front face of the transparent light source gets circularly polarized and emanates out from the reflecting polarizer 304.

Light 305 is extracted from the back face of the transparent light source. Extracted light 305, which is unpolarized, is reflected from the mirror 301 and remains unpolarized. Unpolarized light 307 passes through the quarter wave retarder 303 and remains unpolarized. Further, unpolarized light 307 is incident on the reflecting polarizer 304. Circularly polarized component 308 of light 307 of a particular handedness is transmitted through the reflecting polarizer 304. Circularly polarized component 309 of light 307 of the opposite handedness is reflected back from the reflecting polarizer 304. Circularly polarized component 309 passes through the quarter wave retarder 303 and becomes linearly polarized. Linearly polarized light 310 passes through the transparent linear light source 302. The linear light source 302 being transparent, the polarization state of light 310 is retained. Further, linearly polarized light 310 reflects back from the mirror 301. Mirror reflection of light 310 retains it polarization. Reflected linearly polarized light 311 passes through the transparent linear light source 302. The linear light source 302 being transparent, the polarization state of light 311 is retained. Further, reflected linearly polarized light 311 passes through the quarter wave retarder 303 and becomes circularly polarized with a handedness opposite to that of light 309. Circularly polarized light 312 has a handedness which is transmitted by the reflecting polarizer 304. Circularly polarized light 312 passes through the reflecting polarizer 304. Thus, light 305 extracted from the back face of the transparent light source gets circularly polarized and emanates out from the reflecting polarizer. Thus, light extracted from both the faces of the transparent light source gets circularly polarized and emanates out from the reflecting polarizer.

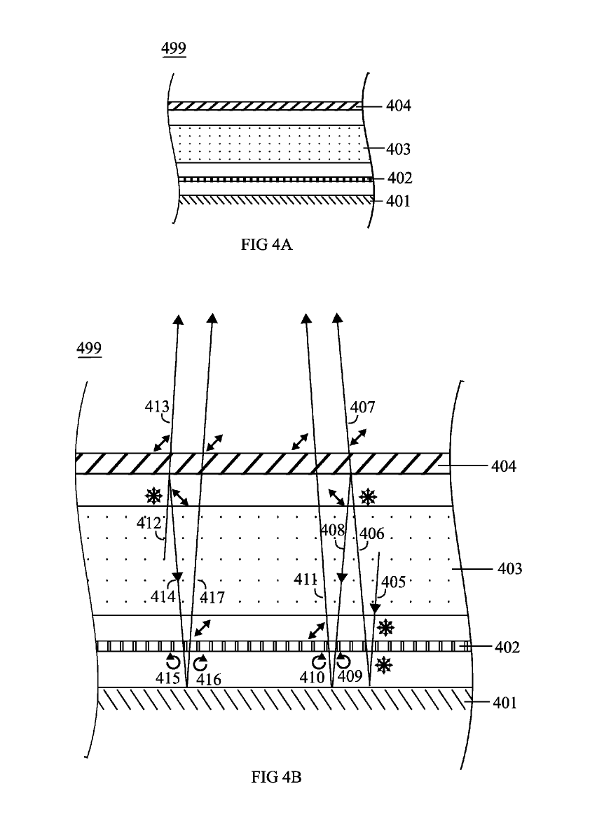

FIG. 4A illustrates a block diagram of a cross section of an exemplary polarized linear light source 499, according to one embodiment. The polarized linear light source 499 comprises a mirror 401. A quarter wave retarder 402 is placed in front of mirror 401. A transparent linear light source 403 is placed in front of the quarter wave retarder 402. A reflecting linear polarizer 404 is placed in front of the transparent linear light source 403. The reflecting linear polarizer 404 allows one linear polarization component of light to pass through it, but reflects back the perpendicular linear polarization component of light. In one embodiment, the optical axis of the quarter wave retarder plate 402 makes an angle of 45 degrees with the direction of polarization of the light reflected back by the linear polarizer. The apparatus 499 is an energy efficient light source which emits linearly polarized light.

FIG. 4B illustrates polarization states of exemplary light rays in a polarized linear light source 499, according to an embodiment. Light is extracted from the transparent linear light source 403 from both its faces. Light 412 is extracted from the front face of the transparent linear light source 403. Extracted light 412, which is unpolarized, is incident on the reflecting polarizer 404. Linearly polarized light component 413 of light 412 having a particular polarization direction emerges out from the reflecting polarizer 404. Linearly polarized light component 414 of light 412 having a polarization direction perpendicular to that of light 413 is reflected back by the polarizer 404. Linearly polarized light component 414 passes through the transparent linear light source 403. The linear light source 403 being transparent, the polarization state of light 414 is retained. Further, linearly polarized light 414 passes through the quarter wave retarder 402 and gets circularly polarized. Circularly polarized light 415 is reflected from the mirror surface 401. Reflected circularly polarized light 416 having a handedness opposite to that of light component 415 passes through the quarter wave 402 and becomes linearly polarized in a direction perpendicular to that of light 414. Linearly polarized light 417 passes through the transparent light source 103 and is incident on the reflecting polarizer 404. The linear light source 403 being transparent, the polarization state of light 417 is retained. Light 417 is linearly polarized in a direction which is transmitted by the reflecting polarizer 404. Light 417 passes through the reflecting polarizer 404. Thus, the light 412 extracted from the front face of the transparent linear light source 403 gets linearly polarized and emanates out from the reflecting polarizer 404.

Light 405 depicts exemplary light which is extracted from the back face of the transparent linear light source 403. Extracted light 405, which is unpolarized, passes through the quarter wave retarder 402 and remains unpolarized. Further, light 405 reflects from the mirror 401. Reflected light 406, which is unpolarized, passes through the transparent linear light source 403. The linear light source 403 being transparent, the polarization state of light 406 is retained. Further, light 406 is incident on the reflecting polarizer 404. Linearly polarized light component 407 of light 406 having a particular direction emerges out from the reflecting polarizer 404. Linearly polarized light component 408 of light 406 polarized in a direction perpendicular to that of light component 407 is reflected back by the polarizer 404. Linearly polarized light component 408 passes through the transparent linear light source 403. The linear light source 403 being transparent, the polarization state of light component 408 is retained. Further, linearly polarized light component 408 passes through the quarter wave retarder 402 and gets circularly polarized. Circularly polarized light 409 is reflected from the mirror surface 401. Reflected circularly polarized light 410 having a handedness opposite to that of light 409 passes through the quarter wave retarder 402 and becomes linearly polarized in a direction perpendicular to that of linearly polarized light component 408. Linearly polarized light 411 passes through the transparent linear light source 403 and is incident on the reflecting polarizer 404. The linear light source 403 being transparent, the polarization state of light 411 is retained. Light 411 is linearly polarized in a direction which is transmitted by the reflecting polarizer 404. Linearly polarized light 411 passes through the reflecting polarizer 404. Thus, the light 405 extracted from the back face of the transparent light source gets linearly polarized and emanates out from the reflecting polarizer 404. Thus, light extracted from both the faces of the transparent light source emerges out from the apparatus in a linearly polarized state.

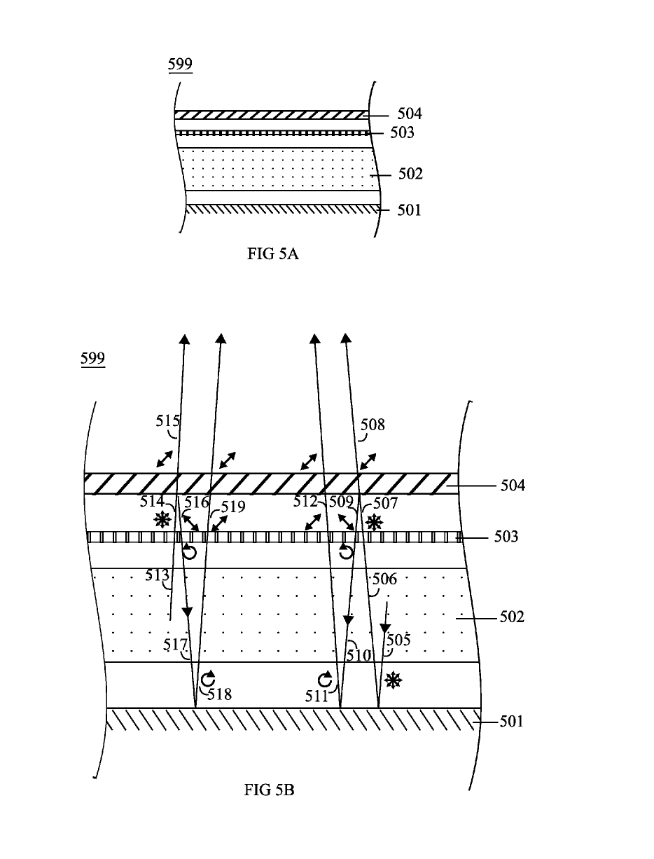

FIG. 5A illustrates a block diagram of a cross section of an exemplary polarized linear light source 599, according to one embodiment. The polarized linear light source 599 comprises a mirror 501. A transparent linear light source 502 is placed in front of the mirror 501. A quarter wave retarder 503 is placed in front of transparent linear light source 502. A reflecting linear polarizer 504 is placed in front of the quarter wave retarder 503. The reflecting linear polarizer 504 allows one linear polarization component of light to pass through it, but reflects back the perpendicular linear polarization component of light. The apparatus 599 is an energy efficient light source which emits linearly polarized light.

FIG. 5B illustrates polarization states of exemplary light rays in a polarized linear light source 599, according to an embodiment. Light is extracted from the transparent linear light source 502 from both its faces. Light 513 is extracted from the front face of the transparent linear light source 502. Extracted light 513, which is unpolarized, passes through the quarter wave retarder 503 and remains unpolarized. Unpolarized light 514 is incident on the reflecting polarizer 504. Linearly polarized light component 515 of light 514 having a particular polarization direction is transmitted through the reflecting polarizer 504. Linearly polarized light component 516 of light 514 having a polarization direction perpendicular to that of light component 515 is reflected back by the reflecting polarizer 504. Linearly polarized component 516 passes through the quarter wave retarder and becomes circularly polarized. Circularly polarized light 517 passes through the transparent linear light source 502 and reflects from the mirror 501. The linear light source 502 being transparent, the polarization state of light 517 is retained. Mirror reflection of light 517 retains its polarization state. Reflected circularly polarized light 518 passes through the transparent linear light source 502. The linear light source 502 being transparent, the polarization state of light 518 is retained. Further, reflected circularly polarized light 518 passes through the quarter wave retarder 502 and becomes linearly polarized in a polarization direction perpendicular to that of light component 516. Linearly polarized light 519 has a polarization direction which is transmitted by the reflecting polarizer 504. Linearly polarized light 519 passes through the reflecting polarizer 504. Thus, light 513 extracted from the front face of the transparent light source gets linearly polarized and emanates out from the reflecting polarizer 504.

Light 505 is extracted from the back face of the transparent light source. Extracted light 505, which is unpolarized, is reflected from the mirror 501 and remains unpolarized. Unpolarized light 506 passes through the quarter wave retarder 503 and remains unpolarized. Unpolarized light 507 is incident on the reflecting polarizer 504. Linearly polarized component 508 of light 507 having a particular polarization direction is transmitted through the reflecting polarizer 504. Linearly polarized component 509 of light 507 having polarization direction perpendicular to that of light component 508 is reflected back from the reflecting polarizer 504. Linearly polarized component 509 passes through the quarter wave retarder 503 and becomes circularly polarized. Circularly polarized light 510 passes through the transparent linear light source 502. The linear light source 502 being transparent, the polarization state of light 510 is retained. Further, circularly polarized light 510 reflects back from the mirror 501. Mirror reflection of light 510 retains it polarization. Reflected circularly polarized light 511 passes through the transparent linear light source 502. The linear light source 502 being transparent, the polarization state of light 511 is retained. Further, reflected circularly polarized light 511 passes through the quarter wave retarder 503 and becomes linearly polarized having a polarization direction perpendicular to that of light component 509. Linearly polarized light 512 has a polarization direction which is transmitted by the reflecting polarizer 504. Linearly polarized light 512 passes through the reflecting polarizer 504. Thus, light 505 extracted from the back face of the transparent light source gets linearly polarized and emanates out from the reflecting polarizer. Thus, light extracted from both the faces of the transparent light source gets linearly polarized and emanates out from the reflecting polarizer.

Linear Light Source

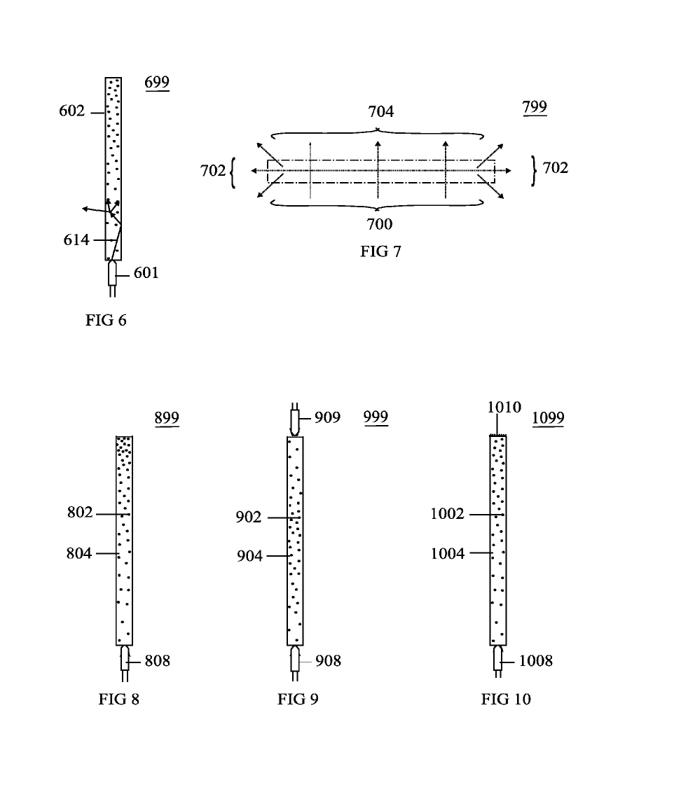

FIG. 6 illustrates a linear light source 699, according to one embodiment. A linear light source is a light source emitting light from a region which has one large dimension. A linear light source could be shaped like a tube with circular, square or other cross section, for example. a bank of LEDs, a fluorescent tube. A point light source 601 is placed near one end of linear light guide 602. A point light source is a light source emitting light from a small region. E.g. an LED (Light Emitting Diode), a LASER (Light Amplification by Stimulated Emission of Radiation) or a filament can act as a point light source. A linear light guide is a light guide with one large dimension. Linear light guide 602 includes a light deflector such as small transparent particles or bubbles, or metallic particles, or dye or pigment, which disperse light by refraction, reflection or by scattering. Light 614 from point light source 601 enters the linear light guide 602 and is guided within it by total internal reflection. This light is deflected by the light deflector, and emanates over the entire surface of linear light guide 602, thus forming a linear light source. The concentration of light deflector particles may be uniform, or may be varied throughout the linear light guide 602 to achieve a required light emanation pattern. If the power emanated by point light source 601 is changed, the light emanation pattern of light source 699 changes proportionately. If more than one point light sources are used, their power may be changed in tandem to change the light emanation pattern proportionately.

In an embodiment, the concentration of light deflector particles is chosen such that the linear light guide 602 is transparent when viewed from its side, but translucent when viewed from an end, making the linear light source 699 transparent to light entering from outside. Such a transparent light source allows light to pass through without changing its polarization state.

FIG. 7 illustrates an exemplary element 799 of a light guide having light deflector, according to one embodiment. Element 799 is a small sliver of the light guide at a particular distance from the end of the light guide that is near a light source. It has a very small height (but the other dimensions of the light guide). The light guide of which element 799 is an element, may be a linear light guide, forming a linear light source.

Light 700, emanated by a light source, and guided by the light guide portion before the element 799, enters element 799. Some of the light gets dispersed due to light deflector included in the light guide, and leaves the light guide as illumination light 702. The remaining light continues on to the next element as light 704. The power of entering light 700 is matched by the sum of the powers of illumination light 702 and continuing light 704. The fraction of dispersed illumination light 702 with respect to entering light 700 is the photic dispersivity of element 799. The ratio of the photic dispersivity of element 799 to the height of element 799 is the photic dispersion density of element 799. As the height of element 799 decreases, the photic dispersion density (of this element) approaches a constant. This photic dispersion density of element 799 bears a certain relationship to the concentration of light deflecting particles in the element 799. The relationship is approximated to a certain degree as a direct proportion. By knowing the concentration of light deflecting particles of element 799, the photic dispersion density of element 799 may be evaluated, and vice versa.

As the height of element 799 is reduced, power in the illumination light 702 reduces proportionately. The ratio of power of illumination light 702 to the height of element 799, which approaches a constant as the height of the element is reduced, is the emanated power density at element 799. The emanated power density at element 799 is the photic dispersion density times the power of entering light 700. The gradient of the power of light traveling through the element 799 is the negative of the emanated power density. These two relations give a differential equation:

dP/dh=−qP=−K

where

h is the distance of the element from the light source end of the light guide,

P is the power of the light being guided through element,

q is the photic dispersion density of element and

K is the emanated power density at element.

This differential equation applies to all elements of the dispersing light guide. It is used to find the emanated power density given the photic dispersion density at each element. This equation is also used to find the photic dispersion density of each element, given the emanated power density. To design a light source with a particular emanated power density pattern (emanated power density as a function of distance from the light source end of the light guide), the above differential equation is solved to determine the photic dispersion density at each element of the light guide. From this, the concentration of light deflecting particles at each element of a light guide is determined.

If a uniform particle concentration is used in the light guide, the emanated power density drops exponentially with distance from the end. Uniform emanated power density may be approximated by choosing a particle concentration such that the power drop from the end near the light source to the opposite end, is minimized. To reduce the power loss and also improve the uniformity of the emanated power, the opposite end reflects light back into the light guide. In an alternate embodiment, another light source provides light into the opposite end.

FIG. 8 illustrates an exemplary linear light source 899 having a varied concentration of light deflecting particles, according to one embodiment. The concentration of light deflecting particles 802 is varied from sparse to dense from the light source end (near light source 808) of light guide 804 to the opposite end.

To achieve uniform illumination, the photic dispersion density and hence the particle concentration has to be varied over the light guide. The photic dispersion density is varied according to

q=K/(A−hK)

where

A is the power going into the light guide 804 and

K is the emanated power density at each element, a constant number (independent of h) for uniform illumination.

If the total height of the light guide 804 is H, then H times K should be less than A, i.e. total power emanated should be less than total power going into the light guide, in which case the above solution is feasible. If the complete power going into the light guide is utilized for illumination, then H times K equals A. In an embodiment, H times K is kept only slightly less than A, so that only a little power is wasted, as well as photic dispersion density is always finite.

FIG. 9 illustrates an exemplary linear light source 999 having two light sources, according to one embodiment. By using two light sources 908, 909, high variations in concentration of light deflecting particles 902 in the light guide 904 is not necessary.

The differential equation provided above is used independently for deriving the emanated power density due to each of the light sources 908, 909. The addition of these two power densities provides the total light power density emanated at a particular light guide element.

Uniform illumination for light source 999 is achieved by varying photic dispersion density according to

q=1/sqrt((h−H/2)̂2+C/K̂2)

where

sqrt is the square root function,

̂ stands for exponentiation, and

C=A(A−HK).

FIG. 10 illustrates an exemplary linear light source 1099 having a mirrored light guide, according to one embodiment. By using a mirrored light guide 1004, high variations in concentration of light deflecting particles 1002 is not necessary. Top end 1010 of the light guide 1004 is mirrored, such that it reflects light back into the light guide 1004.

Uniform illumination for light source 1099 is achieved by varying photic dispersion density according to

q=1/sqrt((h−H)̂2+D/K̂2)

where D=4A(A−HK).

FIG. 11 illustrates a block diagram of an exemplary light source 1199, according to one embodiment. Light source 1199 comprises a light guide 1106 with a core 1104 optionally surrounded by low index cladding sheets 1103 and 1105. The core 1104 includes a light diffuser, which is a sparse distribution of light dispersing particles. The diffuser in the core 1104 is made up of metallic, organic, or other powder, or pigment, which reflects light incident on it. Alternatively, the diffuser in the core 1104 may be constituted of small transparent particles or bubbles, which disperse light. The light dispersion may comprise refraction, reflection at the boundary, diffusion inside the particle, or total internal reflection. Polarized linear light source 1102 illuminates the light source 1106 from bottom edge 1107. The light coupled from the polarized linear light source 1102 into the light source 1199 will be of a particular polarization. The light emanated from the light source 1199 will be partially polarized. A fully polarized light source may be achieved by placing a polarizer in front of light source 1199. The conversion to fully polarized light will be achieved at a higher efficiency, since the light emanated by light source 1199 is partially polarized. The partially polarized light emitted from light guide 1106 can be further polarized by using a reflecting polarizer, a quarter wave plate and a mirror, and then completely polarized efficiently by a polarizer.

In an alternate embodiment, polarization equipment need not be placed in front of the light source 1199 for achieving the polarization. This makes the entire light source system more transparent. As the polarization is achieved in the polarized linear light source 1102 the effective area requirement of the equipment viz. quarter wave retarder and reflective polarizer is reduced, thus reducing the cost of the entire apparatus. The effective increase in efficiency of the light source 1199 is thus achieved at a much lower cost.

In an embodiment, polarized linear light source 1102 produces linearly polarized light, and the axis of linear polarization is parallel to or perpendicular to the axis (large dimension) of the polarized linear light source 1102. The light source 1199 emits partially linearly polarized light in this case.

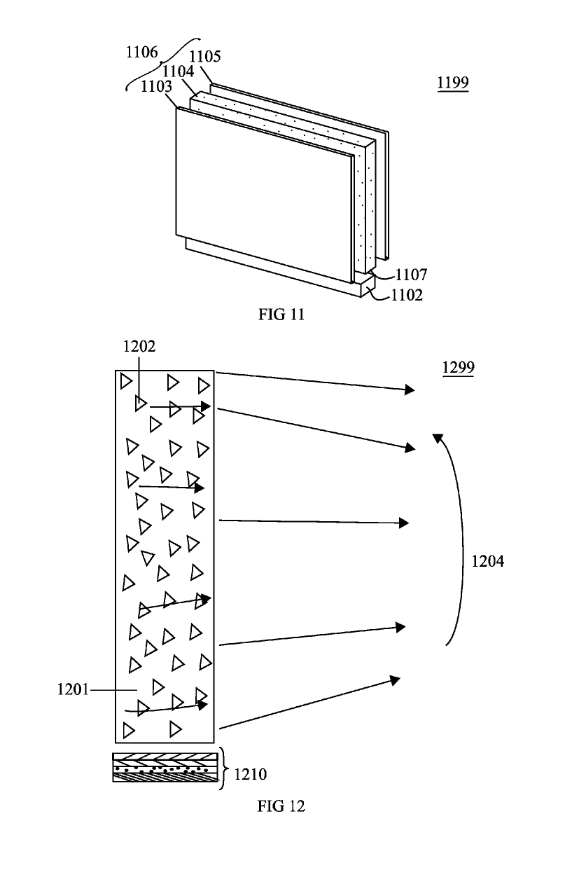

FIG. 12 illustrates an exemplary light source 1299, as seen from the side, according to one embodiment. The light source 1299 comprises a polarized linear light source 1210 and a light guide 1201 with embedded aspherical particles 1202. Polarized linear light source 1210 illuminates the light guide 1201 from a bottom edge. The light coupled from the polarized linear light source 1210 into the light guide 1201 will be of a particular polarization. The polarization of the light coupled into the light guide 1201 will be primarily retained. The emanation pattern 1204 of the light source 1299 can be adjusted as required by adjusting the orientation of the aspherical particles 1202. The emanation pattern 1204 can also be adjusted by choosing the correct particle shapes and sizes in different parts of the light guide 1201. So the light emanated from the light source 1299 will be partially polarized as well as directional. A fully polarized light source may be achieved by placing a polarizer in front of light guide 1201. The conversion to fully polarized light will be achieved at a higher efficiency, since the light emanated by light guide 1201 is partially polarized.

In an alternate embodiment, the polarization equipment need not be placed in front of the light guide 1201 for achieving the polarization. This makes the entire light source system more transparent. As the polarization is achieved in the polarized linear light source 1210 the effective area requirement of the equipment viz. quarter wave retarder, reflective polarizer will reduce, thus reducing the cost of the entire apparatus. The effective increase in efficiency of the light source 1299 is thus achieved at a much lower cost.

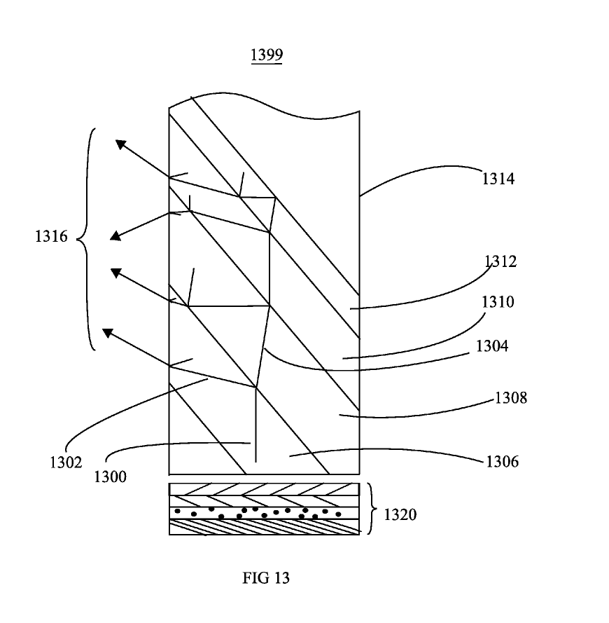

FIG. 13 illustrates a block diagram of an exemplary light source 1399 as viewed from the side, according to one embodiment. The light source 1399 comprises transparent sheets such as sheets 1306, 1308, 1310 and 1312 having different refractive indexes and making a particular angle with the side of light source 1399. In an embodiment the transparent sheets 1306 and 1310 have the same refractive index and transparent sheets 1308 and 1312 have the same refractive index. The light 1300 is incident on the interface between sheets 1306 and 1308. A part of light 1300 reflects as light 1302 and a part refracts as light 1304 into the next sheet 1308. The intensity of refracted light is less than that of incident light at each interface between the transparent sheets. The light 1300 undergoes one or more internal reflections and refractions and is emanated out of the light source 1399 as light 1316. The thicknesses of the transparent sheets 1306, 1308, 1310 and 1312 are varied according to a particular function of distance from bottom edge of sheet 1314. By varying the refractive indexes, slants and thicknesses of the individual sheets 1306, 1308, 1310 and 1312, the emanated light 1316 forms a predetermined light emanation pattern. Polarized linear light source 1320 illuminates the sheet 1314 from a bottom edge. The light coupled from the polarized linear light source 1320 into the sheet 1314 will be of a particular polarization. The polarization of the light coupled into the sheet 1314 will be primarily retained and the light emanated from the light source 1399 will also be partially polarized. A fully polarized light source may be achieved by placing a polarizer in front of the sheet 1314. The conversion to fully polarized light will be achieved at a higher efficiency, since the light emanated by light source 1399 is partially polarized.

In an alternate embodiment, the polarization equipment need not be placed in front of the sheet 1314 for achieving the polarization. This makes the entire light source system more transparent. As the polarization is achieved in the polarized linear light source 1320 the effective area requirement of the equipment viz. quarter wave retarder, reflective polarizer will reduce, thus reducing the cost of the entire apparatus. The effective increase in efficiency of the light source 1399 is thus achieved at a much lower cost.

An energy efficient polarized linear light source system is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising
a reflector,
a reflecting polarizer,
a transparent linear light source placed in between the reflector and the reflecting polarizer, and
a quarter wave retarder.

2. The apparatus of claim 1, wherein the reflecting polarizer is a reflecting circular polarizer.

3. The apparatus of claim 1, wherein the reflecting polarizer is a reflecting linear polarizer.

4. The apparatus of claim 1, wherein the quarter wave retarder is placed in between the reflector and the transparent linear light source.

5. The apparatus of claim 1, wherein the quarter wave retarder is placed in between the transparent linear light source and the reflecting polarizer.

6. An apparatus comprising,
a polarized linear light source, and
a light guide emanating partially polarized light.

7. The apparatus of claim 6, wherein the light guide comprises light dispersing particles.

8. The apparatus of claim 7, wherein the light dispersing particles are aspherical particles.

9. The apparatus of claim 6, wherein the light guide comprises transparent sheets with different refractive indexes.
